(19) United States
(12) Patent Application Publication
(10) Pub. No.: US 2008/0259069 A1
(43) Pub. Date: Oct. 23, 2008

(54) Plasma display device and driving method thereof

(76) Inventor: Jun-Hyung Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/078,139

(22) Filed: Mar. 27, 2008

(30) Foreign Application Priority Data
Mar. 28, 2007 (KR) 10-2007-0030426

(51) Int. Cl. G06F 3/038; G09G 3/28

(52) U.S. Cl. 345/211; 345/60

(57) ABSTRACT

A plasma display may include a plurality of first electrodes, a first switch, a second switch, and a switch driving circuit to control the first switch. The first switch may be between a first power source supplying a first voltage and the plurality of first electrodes. The second switch may be connected between a second power source for supplying a scan voltage to the plurality of first electrodes, and the plurality of first electrodes. The switch driving circuit may include a capacitor and a controller. The capacitor may be between a third power source supplying a third voltage higher than the scan voltage and the second switch. The controller may turn on the first switch using a fourth voltage stored in the capacitor. The capacitor may be charged with the fourth voltage when the second switch is turned on.

### BACKGROUND OF THE INVENTION

1. Field of the Invention

Embodiments relate to a plasma display and a driving method thereof.

2. Description of the Related Art

A plasma display panel (PDP) is a flat panel display that uses plasma generated by gas discharge to display characters or images. Depending on size, a PDP may include more than several scores to millions of pixels arranged in a matrix pattern. One frame of such a plasma display may be divided into a plurality of subfields having weight values. Each subfield may include a reset period, an address period, and a sustain period.

Generally, in the plasma display, the reset period includes a rising period and a falling period. During the rising period of the reset period, a voltage at the scan electrode may be gradually increased to a reset maximum voltage to form a large amount of wall charges on cells. Subsequently, during the falling period of the reset period, the voltage at the scan electrode may be gradually decreased to a reset minimum voltage, so that the wall charges are appropriately erased, allowing an address operation during the address period to be properly performed.

During the address period, a sustain pulse and an address pulse may be respectively applied to the scan electrode and an address electrode of a turn-on discharge cell to select a turn-on cell. During the sustain period, a sustain pulse alternately having a high level voltage and a low level voltage may be applied to the scan electrode and a sustain electrode with opposite phases, so that a sustain discharge is generated on the turn-on cell.

The plasma display may include respective electrode drivers for respectively generating driving waveforms applied to respective electrodes during the reset period, the address period, and the sustain period. Among the electrode drivers, a scan electrode driver may include a reset driver for applying the reset maximum voltage and the reset minimum voltage to the scan electrode during the reset period, a scan driver for applying a scan voltage to the scan electrode during the address period, and a sustain driver for applying a sustain pulse to the scan electrode during the sustain period. Each unit of the scan electrode driver may include a plurality of switches, e.g., transistors.

A switch driving circuit for driving the switch of each unit may include a bootstrap capacitor for stably driving the switch. The switch is driven when a voltage charged in the bootstrap capacitor is applied to the switch through the driving circuit.

However, when the voltage charged in the bootstrap capacitor changes, operation of the switch may become problematic. For example, when the voltage charged in the bootstrap capacitor formed in the driving circuit of the switch forming a path for gradually increasing the voltage at the scan electrode to the reset maximum voltage is changed in the reset driver, a slope of a rising waveform varies, and a problem in a reset discharge may result. In addition, when a voltage is excessively charged in the bootstrap capacitor, a large amount of current flows through the switch at once, so that inner stress of the switch is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display and a driving method thereof, which substantially overcome one or more of the problems due to the limitations and disadvantages of the related art.

It is therefore a feature of an embodiment to provide a plasma display and a driving method thereof in which a switch is more stably driven.

It is therefore a separate feature of an embodiment to provide a plasma display and a driving method thereof in which a switch is less stressfully driven.

At least one of the above and other features and advantages may be realized by providing a plasma display including a plurality of first electrodes, a first switch, a second switch, and a switch driving circuit. The first switch has a first terminal electrically connected to a first power source for supplying a first voltage and a second terminal electrically connected to the plurality of first electrodes. The second switch is electrically connected between a second power source for supplying a scan voltage to the plurality of first electrodes, and the plurality of first electrodes. The switch driving circuit drives the first switch. The switch driving circuit may include a first capacitor connected between a third power source configured to supply a third voltage that is higher than the scan voltage and the second terminal of the first switch. The switch driving circuit may also include a controller configured to receive a fourth voltage charged in the first capacitor and turn on the first switch using the fourth voltage. The capacitor may be charged with the fourth voltage when the second switch is turned on.

At least one of the above and other features and advantages may be realized by providing a method for driving a plasma display including a plurality of first electrodes, a first switch configured to gradually increase a voltage of each of the plurality of first electrodes during a reset period, and a switch driving circuit configured to apply a first voltage stored in a capacitor to a control terminal of the first switch to turn on the first switch. The method may include applying a scan voltage to a first electrode forming a cell to be turned on among the plurality of first electrodes during an address period of a first subfield, charging the capacitor with the first voltage during the address period of the first subfield, applying a sustain pulse to the plurality of first electrodes during a sustain period of the first subfield, and applying the first voltage stored in the capacitor to the control terminal of the first switch during a reset period of a subfield that is subsequent to the first subfield to gradually increase the voltage of each of the plurality of first electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic diagram of a plasma display according to an exemplary embodiment;

FIG. 2 illustrates a driving waveform diagram of the plasma display according to an exemplary embodiment;

FIG. 3 illustrates a diagram of a driving circuit of a scan electrode driver according to an exemplary embodiment;

FIG. 4 illustrates a diagram of a switch driving circuit according to an exemplary embodiment; and

FIG. 5 illustrates a diagram representing a charging path of a bootstrap capacitor according to an exemplary embodiment.

### DETAILED DESCRIPTION OF THE EMBODIMENTS

Korean Patent Application No. 10-2007-0030426 filed on Mar. 28, 2007, in the Korean Intellectual Property Office, and entitled: “Plasma Display Device and Driving Method Thereof,” is incorporated by reference herein in its entirety.

In the following detailed description, only certain exemplary embodiments have been described, simply for illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

Throughout this specification and the claims that follow, the wall charge refers to a charge that is formed on a wall (for example, a dielectric layer) of the discharge cell close to the electrodes to be stored in the electrode. Even though the wall charge is not actually in contact with the electrode, hereinafter, it may be described that the wall charge is formed, accumulated, or stacked on the electrode. Further, the wall voltage refers to a potential difference generated on the wall of the discharge cell by the wall charge.

Throughout this specification and the claims that follow, when it is described that an element is “coupled” to another element, the element may be “directly coupled” to the other element or “electrically coupled” to the other element through a third element.

A plasma display according to an exemplary embodiment and a driving method thereof will now be described with reference to the figures.

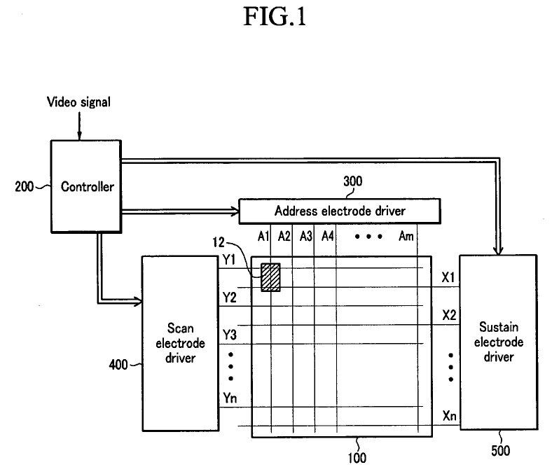

FIG. 1 illustrates a schematic diagram of a plasma display according to an exemplary embodiment. As shown in FIG. 1, the plasma display according to the exemplary embodiment may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, and a plurality of sustain and scan electrodes X1 to Xn and Y1 to Yn extending in a row direction by pairs. The sustain electrodes X1 to Xn may be formed in correspondence to the scan electrodes Y1 to Yn, and the address electrodes A1 to Am may be arranged perpendicular to the scan and sustain electrodes Y1 to Yn and X1 to Xn. Here, a discharge space formed at an area where the address electrodes Al to Am cross the sustain and scan electrodes X1 to Xn and Y1 to Yn forms a cell 12. The configuration of the PDP 100 shown in FIG. 1 is an example, and other exemplary configurations may be employed.

The controller 200 may receive an external video signal and output an address electrode driving control signal, a sustain electrode driving control signal, and a scan electrode driving control signal. In addition, the controller 200 may divide one frame into a plurality of subfields. Each subfield may include a reset period, an address period, and a sustain period.

The address driver 300 may receive the address electrode driving control signal from the controller 200 and may apply a display data signal to each address electrode for selecting discharge cells to be displayed. The scan electrode driver 400 may receive the scan electrode driving control signal from the controller 200 and may apply a driving voltage to the scan electrodes. The sustain electrode driver 500 may receive the sustain electrode driving control signal from the controller 200 and may apply a driving voltage to the sustain electrodes.

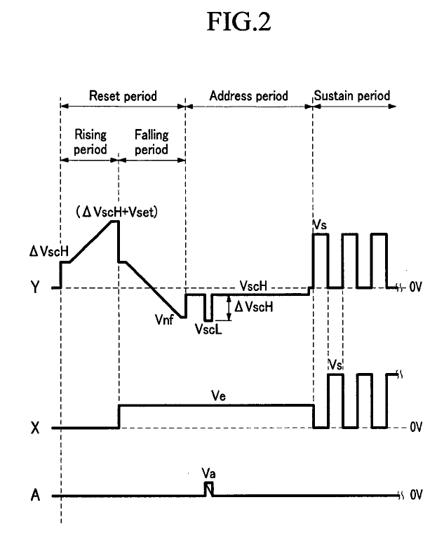

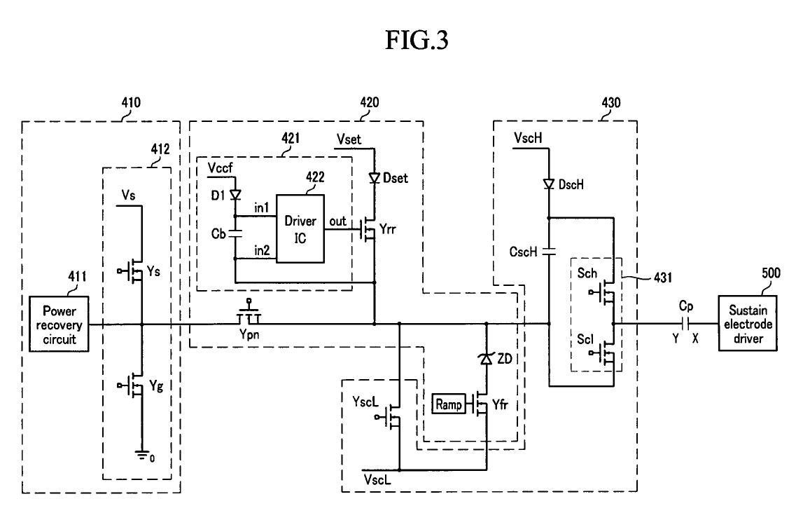

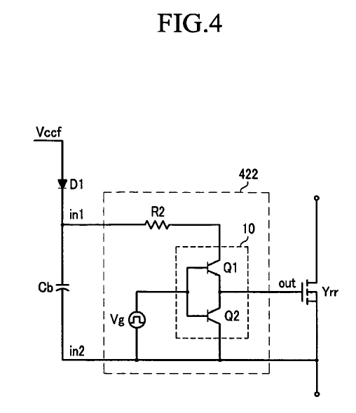

The driving waveform of the plasma display and an operation of the driving circuit according to an exemplary embodiment will be described with reference to FIG. 2 to FIG. 4. FIG. 2 illustrates a driving waveform diagram of the plasma display according to an exemplary embodiment of the present invention. FIG. 3 illustrates a diagram of a driving circuit of the scan electrode driver according to an exemplary embodiment. FIG. 4 illustrates a diagram of a switch driving circuit of FIG. 3 according to an exemplary embodiment.

As shown in FIG. 2, during the rising period of the reset period, while the sustain electrode X and the address electrode A are biased at a reference voltage (0V in FIG. 2), a reset rising waveform for gradually increasing a voltage at the scan electrode Y from a ΔVscH voltage to a voltage of (ΔVscH+Vset) is applied. In FIG. 2, the voltage at the scan electrode Y increases in a ramp pattern. While the voltage at the scan electrode Y gradually increases during the rising period, a weak discharge is generated between the scan electrode Y and the sustain electrode X, a weak discharge is generated between the scan electrode Y and the address electrode A, (−) wall charges are formed on the scan electrode Y, and (+) wall charges are formed on the sustain electrode X and the address electrode A. Since wall voltages formed between the respective electrodes in the plurality of cells are different from each other, the voltage of (ΔVscH+Vset) is set to be large enough to generate discharges in all cells regardless of the wall charges formed therein.

Further, in FIG. 2, a predetermined voltage applied to the scan electrode Y during a rising period starting point of the reset period is the ΔVscH voltage, i.e., a voltage difference between a non-scan voltage VscH and a scan voltage VscL. In other words, the predetermined voltage ΔVscH applied at the rising period starting point is higher than the reference voltage (0V in FIG. 2) by the ΔVscH voltage. In this case, a start voltage of the reset rising waveform may be a high level voltage Vs of the sustain pulse applied to the scan electrode Y and the sustain electrode X during the sustain period. In addition, a Vset voltage is set such that a sum (Vs+Vset) of a Vset voltage and the Vs voltage is greater than a discharge firing voltage.

Subsequently, during the falling period of the reset period, while voltages at the sustain electrode X and the address electrode A are respectively maintained at a bias voltage (a Ve voltage in FIG. 2) and the reference voltage, a reset falling waveform for gradually decreasing the voltage at the scan electrode Y from the ΔVscH voltage to a Vnf voltage is applied. While the voltage at the scan electrode Y is gradually decreased, a weak discharge is generated between the scan electrode Y and the sustain electrode X, and between the scan electrode Y and the address electrode A. Thus, the (−) wall charges formed on the scan electrode Y and the (+) wall charges formed on the sustain and the address electrodes X and A are appropriately erased in order for an address operation to be properly performed.

Subsequently, to select a cell to be turned on during the address period, while the voltage at the sustain electrode X is biased at the Ve voltage, the scan voltage (the VscL voltage in FIG. 2) is sequentially applied to the scan electrodes Y. That is, in a method for sequentially applying the scan voltage to the respective scan electrodes Y, the scan voltage VscL is applied to a first scan electrode Y1, the scan voltage VscL is applied to a second scan electrode Y2, and the scan voltage VscL is applied to a third scan electrode Y3, and so forth.

Then, an address voltage (a Va voltage in FIG. 2) is applied to the address electrode A passing through the cell formed by the scan electrode to which the scan voltage VscL among the scan electrodes Y. Thereby, an address discharge is generated between the address electrode A receiving the address voltage Va and the scan electrode Y receiving the scan voltage VscL, and therefore a cell to be turned on is selected. In this case, the non-scan voltage VscH that is higher than the scan voltage VscL by ΔVscH is applied to the scan electrode to which the scan voltage is not applied, and the reference voltage (0V in FIG. 2) is applied to the address electrode A of the cell that is not selected.

Subsequently, during the sustain period, the sustain pulse is applied to the scan electrode Y and the sustain electrode X. In further detail, the sustain pulse alternately having a high level voltage (the Vs voltage in FIG. 2) and a low level voltage (0V in FIG. 2) is applied to the scan electrode Y and the sustain electrode X. The sustain pulse applied to the scan electrode Y has an opposite phase to that applied to the sustain electrode X. That is, since the low level voltage 0V is applied to the sustain electrode X while the high level voltage Vs is applied to the scan electrode Y, a voltage difference between the two electrodes becomes the Vs voltage. Thereby, the sustain discharge is generated between the scan electrode Y and the sustain electrode X by the wall voltage formed in the cell selected to be turned on during the address period and the voltage of the applied sustain pulse. In this case, the Vs voltage is set to be lower than the discharge firing voltage between the scan electrode Y and the sustain electrode X. Then, the sustain pulse is applied to the scan electrode Y and the sustain electrode X a number of times corresponding to the weight value of the corresponding subfield.

The driving circuit for applying the driving waveforms shown in FIG. 2 to drive the plasma display will now be described with reference to FIG. 3 and FIG. 4. As shown in FIG. 3, the scan electrode driver 400 may include a sustain driver 410, a reset driver 420, and a scan driver 430. While switches are illustrated in FIG. 3 as an n-channel field effect transistor (FET) having a body diode (not shown), other switches performing the same or similar functions may be used. In addition, a capacitance formed by the sustain electrode X, the scan electrode Y, and the address electrode A is represented in FIG. 3 as a panel capacitor Cp.

The sustain driver 410 may include a power recovery circuit 411 and a sustain discharge voltage supply unit 412. The power recovery circuit 411 may be connected to the scan electrode Y of the panel capacitor Cp. The power recovery circuit 411 may increase the voltage at the scan electrode Y to a voltage that is close to the Vs voltage and may decrease the voltage at the scan electrode Y to a voltage that is close to 0V. The sustain discharge voltage supply unit 412 may include transistors Ys and Yg. The transistor Ys may be connected between the scan electrode Y of a panel capacitor Cp and a power source Vs for supplying the Vs voltage to apply the high level voltage Vs of the sustain pulse to the scan electrode Y. The transistor Yg may be connected between the scan electrode Y of the panel capacitor Cp and a ground power source 0V for supplying the 0V voltage to apply the low level voltage 0V of the sustain pulse to the scan electrode Y.

The reset driver 420 may include transistors Yrr, Yfr, and Ypn, a Zener diode ZD, and a diode Dset. The transistor Yrr may form a path for applying the reset rising waveform for gradually increasing the voltage at the scan electrode Y from the ΔVscH voltage to the voltage of (ΔVscH+Vset) during the rising period of the reset period. An absolute value of the Vset voltage may be less than the high level voltage Vs of the sustain pulse applied during the subsequent sustain period.

A drain of the transistor Yrr may be connected to a power source Vset and a source of the transistor Yrr may be connected to the scan electrode Y of the panel capacitor Cp. A drain of the transistor Ypn may be connected to a node of the transistors Ys and Yg, and a source thereof may be connected to a source of the transistor Yrr. The diode Dset may be connected in an opposite direction to a body diode of the transistor Yrr in order to interrupt a current caused by the body diode of the transistor Yrr. A backward current path is formed through a body diode of the transistor Yg when the respective transistors Yfr and YscL are turned on during the reset falling period and the scan period, and the transistor Ypn interrupts the backward current path to prevent the ground power source 0V from being unstable. Accordingly, the transistor Ypn is maintained to be turned off during the reset period and the scan period.

The transistor Yfr may be connected between a power source VscL for supplying the VscL voltage and the scan electrode Y of the panel capacitor Cp. The Zener diode ZD may be connected between the transistor Yfr and the scan electrode Y. Alternatively, the Zener diode ZD may be connected between the power source VscL and the transistor Yfr. The Vnf voltage may be set to be higher than the scan voltage VscL voltage by a breakdown voltage of the Zener diode ZD. Since the Vnf voltage is higher than the VscL voltage, a current path through a body diode of the transistor Yfr may be formed when the transistor YscL is turned on. Accordingly, the transistor Yfr may be formed in a back-to-back manner to interrupt the current path through the body diode of the transistor Yfr.

The scan driver 430 may include a selection circuit 431, a capacitor CscH, a diode DscH, and a transistor YscL. During the address period, the scan driver 430 may apply the scan voltage VscL voltage to the scan electrode Y to select the discharge cell and the non-scan voltage VscH to the scan electrode of the non-discharge cell. The selection circuit 431 may be connected to each of the scan electrodes Y1 to Yn to sequentially select the plurality of scan electrodes Y1 to Yn during the address period, while the sustain driver 410 may be commonly connected to the scan electrodes Y1 to Yn through the selection circuit 431. In FIG. 3, only one selection circuit 431 connected to one scan electrode Y is illustrated for ease of illustration.

The selection circuit 431 may include transistors Sch and Scl. A source of the transistor Sch and a drain of the transistor Scl may be respectively connected to the scan electrode Y of the panel capacitor Cp. A source of the transistor Scl may be connected to a first terminal of the capacitor CscH. A drain of the transistor Sch may be connected to a second terminal of the capacitor CscH.

The transistor YscL may be electrically connected between the power source VscL and the scan electrode Y of the panel capacitor Cp. An anode of the diode DscH may be connected to a power source VscH for supplying the non-scan voltage VscH. A cathode of the diode DscH may be connected to the drain of the transistor Sch. The transistor YscL may be turned on to charge the capacitor CscH with a voltage of (VscH−VscL).

In FIG. 3, the respective transistors Ys, Yg, Yrr, YscL, Yfr, Sch, Scl, and Ypn are illustrated as single transistors, but the respective transistors Ys, Yg, Yrr, YscL, Yfr, Sch, Scl, and Ypn may be formed by a plurality of transistors coupled in parallel. A method and operation for selecting the turn-on cell during the scan period by the scan driver 430 is well known to a person of an ordinary skill in the art, and therefore detailed description thereof will be omitted.

Referring again to the reset driver 420, the reset driver 420 may include a switch driving circuit 421 for driving the transistor Yrr. The switch driving circuit 421 may include a driver integrated circuit (IC) 422 for controlling an operation of the transistor Yrr and a bootstrap capacitor Cb for stably driving the transistor Yrr. The driver IC 422 may use a voltage stored in the bootstrap capacitor Cb as a driving voltage of the transistor Yrr to control a turn-on/off operation of the transistor Yrr.

In further detail, the bootstrap capacitor Cb may be connected between a power source Vccf for supplying a Vccf voltage and a source of the transistor Yrr. As shown in FIG. 3, a first input terminal in1 of the driver IC 422 may be connected to a node of the power source Vccf and the bootstrap capacitor Cb. A second input terminal in2 of the driver IC 422 may be connected to a node of the source of the transistor Yrr and the bootstrap capacitor Cb. In this case, the driver IC 422 receives voltages at both terminals of the bootstrap capacitor Cb through the first and second input terminals, and supplies the voltage charged in the bootstrap capacitor Cb to a gate of the transistor Yrr through an output terminal out.

In addition, a diode D1 may be connected between the power source Vccf and the bootstrap capacitor Cb to prevent the current path from being formed backward. For example, an anode of the diode D1 may be connected to the power source Vccf and a cathode thereof may be connected to a terminal of the bootstrap capacitor Cb.

Details of the switch driving circuit 421 shown in FIG. 3 will be described with reference to FIG. 4. As shown in FIG. 4, the switch driving circuit 421 of the transistor Yrr may include the power source Vccf, the diode D1, the bootstrap capacitor Cb, and the driver IC 422. The driver IC 422 may include a resistor R2, transistors Q1 and Q2, and a gate control power source Vg.

The power source Vccf may be connected to the anode of the diode D1. The cathode of the diode D1 may be connected to a first terminal of the bootstrap capacitor Cb. A first terminal of the resistor R2 may be connected to a node of the diode D1 and the bootstrap capacitor Cb. A second terminal of the resistor R2 may be connected to a collector of the transistor Q1. That is, the first input terminal in1 of the driver IC 422 may be connected to the collector of the transistor Q1 through the resistor R2. An emitter of the transistor Q1 may be connected to an emitter of the transistor Q2. Bases of the transistors Q1 and Q2 are commonly connected to the gate control power source Vg. A collector of the transistor Q2 and a second terminal of the bootstrap capacitor Cb may be connected to the source of the transistor Yrr. That is, the second input terminal of the driver IC 422 is connected to a node of the collector of the transistor Q2 and the source of the transistor Yrr. In this case, the bootstrap capacitor Cb is charged when a voltage applied to the first terminal of the bootstrap capacitor Cb from the power source Vccf through the diode D1 is lower than a voltage of the power source Vccf.

Thus, the transistors Q1 and Q2, here a npn-type transistor Q1 and a pnp-type transistor Q2, form a push-pull circuit 10. When a high signal is output from the gate control power source Vg, the transistor Q1 is turned on, the transistor Q2 is turned off, and the voltage stored in the bootstrap capacitor Cb is applied to the gate of the transistor Yrr to turn of the transistor Yrr. That is, the voltage stored in the bootstrap capacitor Cb is applied to the gate of the transistor Yrr through the transistor Q1 and the output terminal out of the driver IC 422. When a low signal is output from the gate control power source Vg, the transistor Q1 is turned off, the transistor Q2 is turned on, and the transistor Yrr is turned off.

A slope of the reset rising waveform applied to the scan electrode Y of the panel capacitor Cp varies according to the voltage, i.e., the voltage stored in the bootstrap capacitor Cb, supplied to the gate of the transistor Yrr during the rising period of the reset period. Thus, to realize a steady slope, the driving voltage of the transistor Yrr should be maintained at a predetermined voltage. For example, assume that the driving voltage of the transistor Yrr is 15V. When the voltage stored in the bootstrap capacitor Cb is greater than 15V, a relatively large amount of current flows through the transistor Yrr. Therefore, the slope of the reset rising waveform increases. When the voltage stored in the bootstrap capacitor Cb is less than 15V, a relatively small amount of current flows through the transistor Yrr. Therefore, the slope of the reset rising waveform decreases. As described, when the slope of the reset rising waveform varies according to the voltage stored in the bootstrap capacitor Cb, the reset discharge may be unstably generated.

The bootstrap capacitor Cb may be charged by using the ground voltage 0V and a Vcc voltage that is higher the ground voltage by a predetermined voltage. In further detail, during the sustain period of the subfield, the voltage stored in the bootstrap capacitor Cb may be used as a driving voltage of the transistor Yrr in the reset period of a subsequent subfield. For example, when the bootstrap capacitor Cb is connected between a power source Vcc that is higher than the ground voltage by the predetermined voltage (e.g., ISV) and the source terminal of the transistor Yrr and the transistor Yg of the sustain discharge voltage supply unit 412 is turned on, the bootstrap capacitor Cb is charged with ISV. When the ground voltage is used as the reference voltage in a charging path of the bootstrap capacitor Cb, the voltage stored in the bootstrap capacitor Cb may vary according to each screen load ratio in the sustain period of each subfield. That is, when the panel capacitor Cp varies according to the screen load ratio, an under-shoot may be caused by hard switching when the low level voltage 0V of the sustain pulse is applied to the panel capacitor Cp during the sustain period of a predetermined subfield. Since the bootstrap capacitor Cb is over-charged, the slope of the reset rising waveform varies during the reset period of a subsequent subfield.

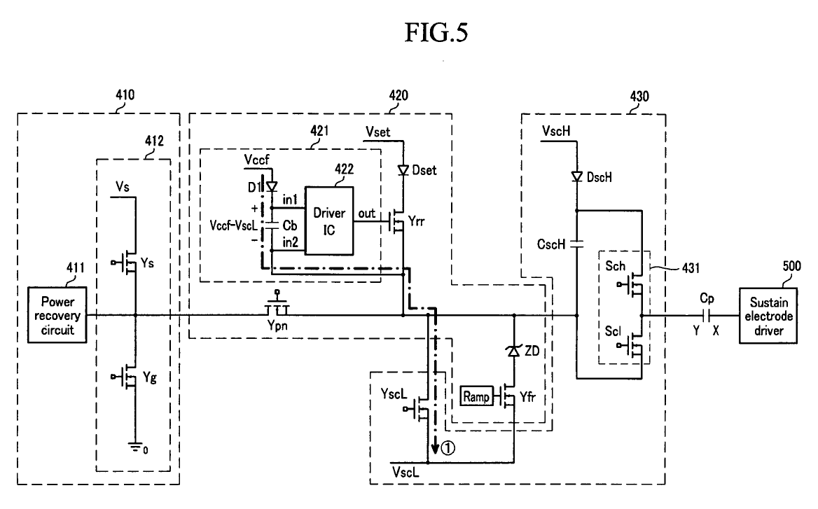

Accordingly, in an exemplary embodiment, a charging path for charging a predetermined voltage to the bootstrap capacitor Cb in the switch driving circuit 421 of the transistor Yrr may be formed such that the predetermined voltage is realized regardless of the screen load ratio. FIG. 5 illustrates a diagram representing a charging path of the bootstrap capacitor Cb according to an exemplary embodiment.

That is, as shown in FIG. 5, a charging path \textcircled{1} of the bootstrap capacitor Cb may be formed when the transistor YscL of the scan driver 430 is turned on. In this case, the Vccf voltage supplied from the power source Vccf is a voltage that is higher than the scan voltage VscL applied to the scan electrode during the address period by a predetermined voltage. For example, when the Vccf voltage is higher than the scan voltage VscL by 15V, the bootstrap capacitor Cb is charged with 15V.

In further detail, in a period for turning on the transistor YscL during the address period of a predetermined subfield, the bootstrap capacitor Cb is charged with a voltage difference (Vccf−VscL) between the Vccf voltage and the scan voltage VscL. Subsequently, when the voltage 15V charged in the bootstrap capacitor Cb is applied during the reset period of a subfield subsequent to the predetermined subfield, the transistor Yrr is turned on. As described, since the bootstrap capacitor Cb is charged with a predetermined voltage by using the scan voltage VscL, the slope of the reset rising waveform may be stable. In addition, since the amount of current flowing to the transistor Yrr of the driving circuit becomes stable, an internal stress of elements may be reduced. In this case, when the plasma display is turned on, in accordance with an exemplary embodiment, the driving voltage of the transistor Yrr has been charged in the bootstrap capacitor Cb according to predetermined internal power sequence before an initial subfield is driven.

Further, while the driver IC 422 is used as the switching controller for controlling the transistor Yrr in an exemplary embodiment, other control mechanisms using the voltage stored in the bootstrap capacitor Cb to control the transistor Yrr may be used.

According to the exemplary embodiment of the present invention, since the switch for generating the reset rising waveform is stably driven, the reset discharge may be stably generated. In addition, since the internal stress of the switch is reduced, the circuit is prevented from being inappropriately operated.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display, comprising:
a plurality of first electrodes;
a first switch having a first terminal electrically connected to a first power source configured to supply a first voltage and a second terminal electrically connected to the plurality of first electrodes;
a second switch having a first terminal electrically connected to a second power source configured to supply a scan voltage to the plurality of first electrodes and a second terminal electrically connected to the plurality of first electrodes; and
a switch driving circuit for driving the first switch, the switch driving circuit including
a capacitor connected between a third power source configured to supply a third voltage that is higher than the scan voltage and the second terminal of the first switch, and
a controller configured to receive a fourth voltage stored in the capacitor and to turn on the first switch using the fourth voltage, wherein the capacitor is charged with the fourth voltage when the second switch is turned on.

2. The plasma display as claimed in claim 1, wherein the fourth voltage is an absolute value of a voltage difference between the third voltage and the scan voltage.

3. The plasma display as claimed in claim 2, wherein the first switch is turned on in a reset period of each subfield to gradually increase a voltage of each of the plurality of first electrodes.

4. The plasma display as claimed in claim 3, wherein the second switch is turned on during an address period of each subfield to apply the scan voltage to the plurality of first electrodes.

5. The plasma display as claimed in claim 4, wherein the controller comprises:
a first input terminal connected to a node of the third power source and the capacitor;
a second input terminal connected to a node of the second power source and the capacitor; and
an output terminal connected to a control terminal of the first switch.

6. The plasma display as claimed in claim 5, wherein the controller comprises a push-pull circuit configured to turn on the first switch by connecting the first input terminal and the output terminal in response to a control signal turning on the first switch, and to turn off the first switch by connecting the second input terminal and the output terminal in response to a control signal turning off the first switch.

7. The plasma display as claimed in claim 6, wherein the capacitor is charged during the address period of a predetermined subfield, and the fourth voltage charged in the capacitor is applied to the control terminal of the first switch during the reset period of a subfield that is subsequent to the predetermined subfield.

8. The plasma display as claimed in claim 7, wherein the switch driving circuit further comprises a diode having an anode connected to the third power source and a cathode connected to the capacitor.

9. The plasma display as claimed in claim 8, wherein the switch driving circuit further comprises a resistor between the first input terminal and the push-pull circuit.

10. The plasma display as claimed in claim 1, wherein the switch driving circuit further comprises a diode having an anode connected to the third power source and a cathode connected to the capacitor.

11. The plasma display as claimed in claim 1, wherein the controller is a driver integrated circuit.

12. A method for driving a plasma display including a plurality of first electrodes, a first switch configured to gradually increase a voltage of each of the plurality of first electrodes during a reset period, and a switch driving circuit configured to apply a first voltage stored in a capacitor to a control terminal of the first switch to turn on the first switch, the method comprising:
applying a scan voltage to a first electrode forming a cell to be turned on among the plurality of first electrodes during an address period of a first subfield;
charging the capacitor with the first voltage during the address period of the first subfield;
applying a sustain pulse to the plurality of first electrodes during a sustain period of the first subfield; and
applying the first voltage stored in the capacitor to the control terminal of the first switch during a reset period of a subfield that is subsequent to the first subfield to gradually increase the voltage of each of the plurality of first electrodes.

13. The method as claimed in claim 12, wherein the switch driving circuit further comprises a first power source for supplying a second voltage that is higher than the scan voltage, and the first voltage is an absolute value of a voltage difference between the scan voltage and the second voltage.

14. The method as claimed in claim 13, wherein the plasma display further includes a second switch configured to apply the scan voltage to the plurality of first electrodes, and charging the capacitor includes forming a charging path of the capacitor when the second switch is turned on during the address period of the first subfield.

15. The method as claimed in claim 14, wherein the capacitor includes a first terminal connected to the first power source, and a second terminal connected to a node of the first and second switches.

16. The method as claimed in claim 12, wherein the plasma display further includes a second switch configured to apply the scan voltage to the plurality of first electrodes, and charging the capacitor includes forming a charging path of the capacitor when the second switch is turned on during the address period of the first subfield.
